(19) United States
(12) Patent Application Publication
(10) Pub. No.: US 2024/0249204 A1
(43) Pub. Date: Jul. 25, 2024

(54) Active Selective Prediction Using Ensembles and Self-training

(71) Applicant: Google LLC, Mountain View, CA (US)

(72) Inventors: Jinsung Yoon, San Jose, CA (US); Jiefeng Chen, Mountain View, CA (US); Sayna Ebrahimi, Los Altos Hills, CA (US); Sercan Omer Arik, San Francisco, CA (US)

(73) Assignee: Google LLC, Mountain View, CA (US)

(21) Appl. No.: 18/419,476

(22) Filed: Jan. 22, 2024

Related U.S. Application Data
(60) Provisional application No. 63/481,420, filed on Jan. 25, 2023.

(51) Int. Cl. G06N 20/20

(52) U.S. Cl. CPC G06N 20/20

(57) ABSTRACT

A method includes obtaining a set of unlabeled test data samples and, for each respective initial training step, determining a first average output for each unlabeled test data sample using a deep ensemble. For each round of a plurality of rounds, the method includes selecting a subset of unlabeled test data samples based on the determined first average outputs, labeling each respective unlabeled in the subset of unlabeled test data samples, fine-tuning the deep ensemble model using the subset of labeled test data samples, and determining a second average output for each unlabeled test data sample using the fine-tuned deep ensemble model. The method also includes generating, using the set of unlabeled test data samples and the determined second average outputs, a pseudo-labeled set of training data samples. The method also includes training the deep ensemble model using the pseudo-labeled set of training data samples.

### CROSS REFERENCE TO RELATED APPLICATIONS

This U.S. patent application claims priority under 35 U.S.C. § 119(e) to U.S. Provisional Application 63/481,420, filed on Jan. 25, 2023. The disclosure of this prior application is considered part of the disclosure of this application and is hereby incorporated by reference in its entirety.

### TECHNICAL FIELD

This disclosure relates to using active selective prediction with ensembles and self-training.

### BACKGROUND

Deep Neural Networks (DNNs) have shown notable success in many applications that require complex understanding of input data. However, success usually relies on the assumption that the same distribution in an independent and identical way. In practice, this assumption may not hold. For example, for a satellite imaging application, weather conditions might cause corruptions, shifting the distribution; or for a retail demand forecasting application, changes in fashion trends might alter the consumer behavior; or for a disease outcome prediction application, a new pandemic might change patient outcomes, etc. When the assumption does not hold (i.e., the test data is from a different distribution compared to the training data), the pre-trained model can suffer from a large performance drop on the test data. This might be due to overfitting to spurious patterns during the pre-training that are not consistent across training and test data.

### SUMMARY

One aspect of the disclosure provides a computer-implemented method that when executed on data processing hardware causes the data processing hardware to perform operations for bridging a gap between active learning and selective prediction. The operations include obtaining a set of unlabeled test data samples. For each respective initial step of a plurality of initial training steps, the operations include determining a first average output for each unlabeled test data sample of the set of unlabeled test data samples using a deep ensemble model pre-trained on a plurality of source training samples. For each round of a plurality of rounds, the operations include: selecting, from the set of unlabeled training data, a subset of unlabeled training data samples based on the determined first average outputs; labeling each respective unlabeled training data sample in the subset of unlabeled training data samples; fine-tuning the deep ensemble model using the subset of labeled training data samples; and determining, using the fine-tuned deep ensemble model, a second average output for each unlabeled test data sample of the set of unlabeled test data samples. The operations also include generating a pseudo-labeled set of training data samples using the set of unlabeled training data samples and the determined second average outputs. The operations also include training the deep ensemble model using the pseudo-labeled set of training data samples.

Implementations of the disclosure may include one or more of the following optional features. In some implementations, labeling each respective unlabeled test data sample in the set of unlabeled test data samples includes obtaining, from an oracle, for each respective unlabeled test data sample in the set of unlabeled test data samples, a corresponding label for the respective unlabeled test data sample. In these implementations, the oracle may include a human annotator. Training the deep ensemble model using the pseudo-labeled set of training data samples may include using a stochastic gradient descent technique. In some examples, the deep ensemble model includes an ensemble of one or more machine learning models and training the deep ensemble model using the pseudo-labeled set of training data samples includes training each machine learning model with a different randomly selected subset of the pseudo-labeled set of training data samples. In these examples, determining the first average output for each unlabeled test data sample includes, for each respective unlabeled test data sample, determining a prediction and a confidence value indicating a likelihood that the prediction is correct for each machine learning model of the one or more machine learning models and averaging the confidence values determined by each machine learning model for the respective unlabeled test data sample.

In some implementations, selecting, from the set of unlabeled test data samples, the subset of unlabeled test data samples based on the determined first average outputs includes selecting the unlabeled test data samples including the lowest determined first average outputs. Fine-tuning the deep ensemble model using the subset of labeled test data samples includes jointly fine-tuning the deep ensemble model using the subset of labeled test data samples and the plurality of source training samples. In some examples, fine-tuning the deep ensemble model using the subset of labeled test data samples includes determining a cross-entropy loss. Training the deep ensemble model using the pseudo-labeled set of training data samples may include determining a KL-Divergence loss.

Another aspect of the disclosure provides a system that includes data processing hardware and memory hardware storing instructions that when executed on the data processing hardware causes the data processing hardware to perform operations. The operations include obtaining a set of unlabeled test data samples. For each respective initial step of a plurality of initial training steps, the operations include determining a first average output for each unlabeled test data sample of the set of unlabeled test data samples using a deep ensemble model pre-trained on a plurality of source training samples. For each round of a plurality of rounds, the operations include: selecting, from the set of unlabeled training data, a subset of unlabeled training data samples based on the determined first average outputs; labeling each respective unlabeled training data sample in the subset of unlabeled training data samples; fine-tuning the deep ensemble model using the subset of labeled training data samples; and determining, using the fine-tuned deep ensemble model, a second average output for each unlabeled test data sample of the set of unlabeled test data samples. The operations also include generating a pseudo-labeled set of training data samples using the set of unlabeled training data samples and the determined second average outputs. The operations also include training the deep ensemble model using the pseudo-labeled set of training data samples.

Implementations of the disclosure may include one or more of the following optional features. In some implementations, labeling each respective unlabeled test data sample in the set of unlabeled test data samples includes obtaining, from an oracle, for each respective unlabeled test data sample in the set of unlabeled test data samples, a corresponding label for the respective unlabeled test data sample. In these implementations, the oracle may include a human annotator. Training the deep ensemble model using the pseudo-labeled set of training data samples may include using a stochastic gradient descent technique. In some examples, the deep ensemble model includes an ensemble of one or more machine learning models and training the deep ensemble model using the pseudo-labeled set of training data samples includes training each machine learning model with a different randomly selected subset of the pseudo-labeled set of training data samples. In these examples, determining the first average output for each unlabeled test data sample includes, for each respective unlabeled test data sample, determining a prediction and a confidence value indicating a likelihood that the prediction is correct for each machine learning model of the one or more machine learning models and averaging the confidence values determined by each machine learning model for the respective unlabeled test data sample.

In some implementations, selecting, from the set of unlabeled test data samples, the subset of unlabeled test data samples based on the determined first average outputs includes selecting the unlabeled test data samples including the lowest determined first average outputs. Fine-tuning the deep ensemble model using the subset of labeled test data samples includes jointly fine-tuning the deep ensemble model using the subset of labeled test data samples and the plurality of source training samples. In some examples, fine-tuning the deep ensemble model using the subset of labeled test data samples includes determining a cross-entropy loss. Training the deep ensemble model using the pseudo-labeled set of training data samples may include determining a KL-Divergence loss.

The details of one or more implementations of the disclosure are set forth in the accompanying drawings and the description below. Other aspects, features, and advantages will be apparent from the description and drawings, and from the claims.

### DESCRIPTION OF DRAWINGS

FIG. 1 is a schematic view of an example system for training an ensemble model using active selection prediction and self-training.

FIG. 2 is a schematic view of an example initial training step of a plurality of training steps.

FIG. 3 is a schematic view of generating pseudo-labeled training samples.

FIG. 4 illustrates an example algorithm for training the ensemble model using active selection prediction and self-training.

FIG. 5 a flowchart of an example arrangement of operations for a method of bridging a gap between active learning and selective prediction.

FIG. 6 is a schematic view of an example computing device that may be used to implement the systems and methods described herein.

Like reference symbols in the various drawings indicate like elements.

### DETAILED DESCRIPTION

Deep Neural Networks (DNNs) have made significant performance improvements in many different applications that make predictions by processing input data. DNNs are trained using training data and then deployed or tested to process test data. In some scenarios, however, a distribution shift exists between the training data and the test data. For example, the distribution shift may include: for a satellite imaging application, weather conditions might cause corruptions that alter the satellite images thereby shifting the distribution; for a retail demand forecasting application, changes in fashion trends might alter the consumer behavior; and for a disease outcome prediction application, a new pandemic might change patient outcome. When the distribution shift exists between the training data and the test data, the DNNs can suffer performance degradations during inference or testing.

The performance degradation caused by distribution shift may be unacceptable for some applications where accuracy is critical. Thus, in some instances, when DNNs make predictions that have confidence values that fail to satisfy a certain threshold, the DNNs defer to humans to make the predictions. This approach of deferring to humans to predict or manually annotate the data when the DNN is uncertain about a particular prediction is referred to as selective prediction. Although selective prediction results in predictions that are more reliable, it comes at a cost of increased human intervention. For example, if a model achieves 80% accuracy on a test data set, an ideal selective prediction algorithm should reject 20% of the test data set as misclassified samples and send this 20% of the test data to a human to review and annotate. In some scenarios, humans may only annotate a small portion of the misclassified samples due to budget constraints.

Accordingly, implementations herein are directed towards methods and systems of an active selective prediction model trainer. The model trainer obtains a set of unlabeled test data samples and, for each respective initial training step, determines a first average output for each unlabeled test data sample using a deep ensemble model pre-trained on a plurality of source training samples. Notably, the unlabeled test data samples and the source training samples may correspond to a same domain, but include a distribution shift. For each round of a plurality of rounds, the model trainer selects, from the set of unlabeled test data samples, a subset of unlabeled test data samples based on the determined first average outputs; labels each respective unlabeled test data sample in the subset of unlabeled test data samples; fine-tunes the deep ensemble model using the subset of labeled test data samples; and determines, using the fine-tuned deep ensemble model, a second average output for each unlabeled test data sample of the set of unlabeled test data samples. The model trainer also generates a pseudo-labeled set of training data samples using the set of unlabeled test data samples and the determined second average outputs and trains the deep ensemble model using the pseudo-labeled set of training data samples.

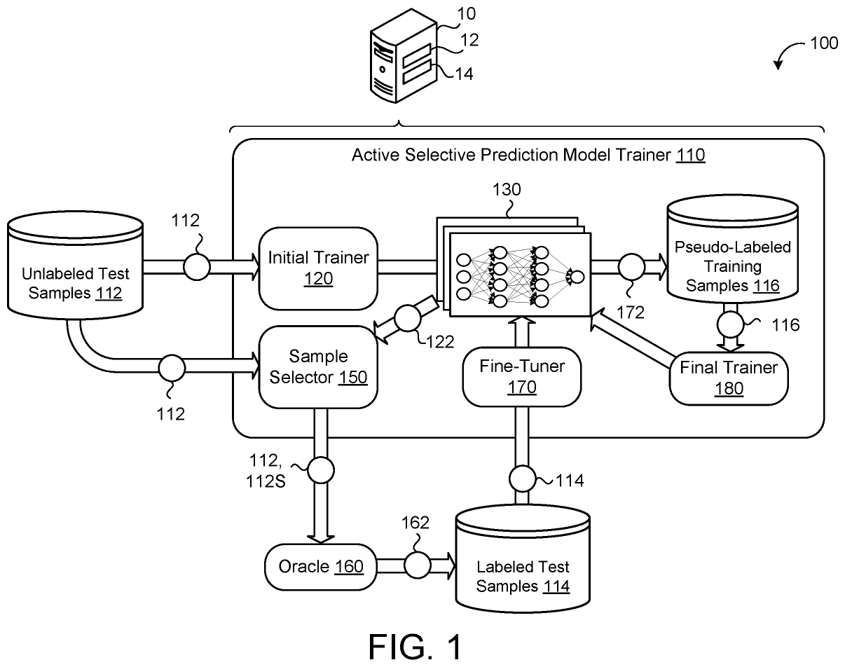

Referring to FIG. 1, in some implementations, an example system 100 includes a processing system 10. The processing system 10 may be a single computer, multiple computers, or a distributed system (e.g., a cloud environment) having fixed or scalable/elastic computing resources 12 (e.g., data processing hardware) and/or storage resources 14 (e.g., memory hardware). The processing system 10 executes an active selective prediction model trainer (e.g., model trainer) 110. The model trainer 110 trains a deep ensemble model (e.g., deep neural network (DNN)) 130 to make predictions based on input data. For example, the model trainer 110 trains one or more convolutional neural networks (CNN). The deep ensemble model 130 may include an ensemble of machine learning models (e.g., two or more machine learning models) 130. As such, deep ensemble model 130 and machine learning models 130 may be used interchangeably herein. In some examples, the model trainer 110 initially pre-trains the deep ensemble model on a source training dataset D^{tr} sampled from a training data distribution P with probability density function P(x,y). In other examples, the model trainer 110 obtains the deep ensemble model 130 which has already been trained on the source training dataset D^{tr}.

The model trainer 110 obtains a set of unlabeled test data samples 112 to adapt the deep ensemble model 130. In particular, the deep ensemble model 130 may be pre-trained on the source training dataset D^{tr} and the model trainer 110 may adapt the deep ensemble model to make accurate predictions for the set of unlabeled test data samples 112. An unlabeled test data sample 112 refers to data that does not include any annotations or other indications of the correct result for the deep ensemble model 130 to predict (i.e., a “ground truth”) which is in contrast to labeled data that does include such annotations. For example, labeled data for a deep ensemble model 130 that is trained to transcribe audio data characterizing an utterance includes the audio data as well as a corresponding accurate transcription (i.e., a ground-truth transcription) of the utterance. An unlabeled test data sample 112 for the same deep ensemble model 130 would include the audio data without the transcription. With labeled data, the deep ensemble model 130 may make a prediction based on a training sample and then easily compare the prediction to the label serving as a ground-truth label to determine how accurate the prediction was. Thereafter, training techniques such as stochastic gradient descent (SGD) may be used to train the deep ensemble model 130 on losses ascertained between the prediction and the ground-truth labels in a supervised manner. In contrast, such feedback is not available with the unlabeled test data samples 112.

The unlabeled test data samples 112 may be representative of any data the deep ensemble model 130 requires to make its predictions. For example, the unlabeled training data may include frames of image data (e.g., for object detection or classification, etc.), frames of audio data (e.g., for transcription or speech recognition, etc.), and/or text (e.g., for natural language classification, etc.). The unlabeled test data samples 112 may be stored on the processing system 10 (e.g., at the memory hardware 14) or received, via a network or other communication channel, from another entity. The unlabeled test data samples 112 may include samples from a same domain as samples from the source training dataset D^{tr} used to pre-train the deep ensemble model 130. For instance, the unlabeled test data samples 112 and the source training dataset D^{tr} may both include image data, audio data, and/or text data. In some implementations, a distribution shift exists between the source training dataset D^{tr} and the unlabeled test data samples 112. For example, the source training dataset D^{tr} includes satellite imaging data of a particular region before a severe weather condition (e.g., hurricane, tornado, earthquake, etc.) occurs and the unlabeled test data samples 112 includes satellite imaging data of the particular region after the severe weather condition occurs. In this example, the destruction caused by the severe weather condition captured by the satellite image represents the distribution shift between the source training dataset D^{tr} and the unlabeled test data samples 112. In another example, the source training dataset D^{tr} includes audio data spoken by sportscasters and the unlabeled test data samples 112 includes audio data spoken by news anchors. Here, the difference in cadence, pitch, and intonation between sportscasters and news anchors represent the distribution shift between the source training dataset D^{tr} and the unlabeled test data samples 112.

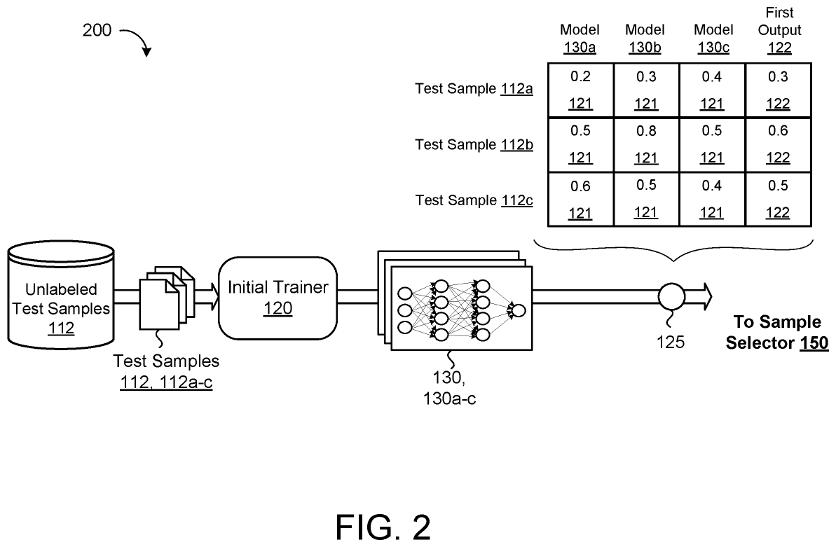

The model trainer 110 includes an initial trainer 120. The initial trainer 120 initially pre-trains the deep ensemble model 130 using the source training dataset D^{tr}. Here, the source training dataset D^{tr} includes input samples paired with corresponding ground-truth samples in order to pre-train the deep-ensemble model 130 to learn how to make accurate predictions from input samples. In some examples, the initial trainer 120 pre-trains the deep ensemble model 130 on the source training dataset D^{tr} using SGD with different randomness for each model of the deep ensemble model 130. The initial trainer 120 may train or fine-tune the deep ensemble model 130 using a training objective that includes a cross-entropy loss and model parameters for each respective model of the deep ensemble model 130. For each respective initial training step 200 (FIG. 2) of a plurality of initial training steps 200, the initial trainer 120 determines a first average output 122 for each unlabeled test data sample 112 of the set of unlabeled test data samples 112 using the deep ensemble model 130 pre-trained on the plurality of source training samples D^{tr}.

FIG. 2 illustrates an example initial training step 200 of the plurality of initial training steps 200. In the example shown, the initial trainer 120 obtains a set of three unlabeled test data samples 112, 112a-c and provides the set of unlabeled test data samples 112 to the deep ensemble model 130. The initial trainer 120 may obtain the entire set of unlabeled test data samples 112 or a subset thereof. In this example, the deep ensemble model 130 includes three machine learning models 130, 130a-c, however, the deep ensemble model 130 may include any number of machine learning models 130 and the initial trainer 120 may obtain any number of unlabeled test data samples 112. Each machine learning model 130 of the deep ensemble model 130 generates an output 125 for each respective unlabeled test data sample 112. Each output 125 may include a prediction (not shown) for the respective unlabeled test data sample 112 and a confidence value 121 (e.g., softmax output value) indicating a likelihood that the prediction generated by the machine learning model 130 is correct. The prediction may be a classification, transcription, or other prediction based on processing the unlabeled test data sample 112. For instance, for a respective unlabeled test data sample 112 including audio data, the prediction may be a transcription of speech included in the audio data. Here, the confidence value 121 would indicate the likelihood that the transcription accurately reflects the speech included in the audio data.

Continuing with the example above, a first machine learning model 130a determines confidence values 121 of 0.2, 0.5, and 0.6 for the three unlabeled test data samples 112a-c, respectively. Similarly, a second machine learning model 130b determines confidence values 121 of 0.3, 0.8, and 0.5 for the three unlabeled test data samples 112a-c, respectively, and a third machine learning model 130c determines confidence values 121 of 0.4, 0.5, and 0.4 for the three unlabeled test data samples 112a-c, respectively. As such, the deep ensemble model 130 determines the first average output 122 for each respective unlabeled test data sample 112 by averaging the confidence values 121 generated by each machine learning model 130 of the deep ensemble model 130 for each respective unlabeled test data sample 112. The first average output 122 may represent an average of the softmax output values output by the deep ensemble model 130. For instance, for the first unlabeled test data sample 112a, the deep ensemble model 130 determines the first average output 122 of 0.3 by averaging the three confidence values 121 of 0.2, 0.3, and 0.4 determined by each of the machine learning models 130 of the deep ensemble model 130. Similarly, the deep ensemble model 130 determines the first average output 122 of 0.6 for the second unlabeled test data sample 112b and the first average output of 0.5 for the third unlabeled test data sample 112c. The initial trainer 120 sends the outputs 125 (e.g., including the first average outputs 122) to a sample selector 150.

Referring again to FIG. 1, after determining the first average outputs 122 using the deep ensemble model 130 trained on the source training dataset D^{tr}, the model trainer 110 performs a respective round of a plurality of rounds. That is, after each initial training step 200 (FIG. 2), the model trainer 110 performs a respective round of the plurality of rounds. After performing the respective round, the model trainer 110 performs another initial training step 200 (FIG. 2). This process may continue for any number of initial training steps 200 and any number of rounds. During each round of the plurality of rounds, the model trainer 110 performs active learning on the deep model ensemble 130 using the sample selector 150, an oracle 160, and a fine-tuner 170. As used herein, active learning refers to selecting a subset of unlabeled samples, labeling them using an oracle (e.g., human annotator), and training the model using the subset of samples labeled by the human annotator. For each round, the sample selector 150 samples or selects a subset of the unlabeled test data samples 112, 112S based on the determined first average outputs 122. In some examples, the sample selector 150 may select the subset of the unlabeled test data samples 112S by selecting the unlabeled test data samples 112 having the lowest determined first average outputs 122 (e.g., lowest likelihood of having correct predictions) according to:

$${B}_{t} = arg {max}_{B ⊂ {U}_{X} / ( {⋃}_{l = 0}^{t - 1} {B}_{l} ) , \vert B \vert = m} - {\sum }_{{x}_{i} ∈ B} S ( {x}_{i} ) \qquad ( 1 )$$

That is, the selected subset of unlabeled test data samples 112S have the greatest uncertainty of having correct predictions. Selecting the unlabeled test data samples 112 having the lowest determined first average outputs 122 may either make the predictions of the deep ensemble model 130 more accurate or make the deep ensemble model have higher confidence values 121 on the correct predictions generated by the deep ensemble model 130. Each round of the plurality of rounds, may be constrained to selecting a predetermined number of unlabeled test data samples 112 (e.g., labeling budget) in the subset of unlabeled test data samples 112S.

The sample selector 150 may send the selected unlabeled test data samples 112 to an oracle 160. In some examples, the oracle 160 is a human annotator or other human agent that manually reviews the subset of unlabeled test data samples 112S and determines corresponding ground truth labels 162. That is, the oracle 160, in response to receiving the subset of unlabeled test data samples 112S, determines or otherwise obtains the corresponding ground truth label 162 for each unlabeled test sample 112 in the subset of unlabeled test data samples 112S. The subset of unlabeled test samples 112S, combined with the ground truth labels 162 determined by the oracle 160, form a subset of labeled test data samples 114. That is, in contrast to the unlabeled test samples 112 that are not paired with any corresponding ground truth labels, the subset of labeled test data samples 114 are each paired with a corresponding ground truth label determined by the oracle 160.

A fine-tuner 170 fine-tunes, using subset of labeled test data samples 114 (i.e., the selected subset of unlabeled test data samples 112S and the corresponding ground truth labels 162 determined by the oracle 160), the deep ensemble model 130 that is already pre-trained on the source training samples D^{tr}. In some examples, the fine-tuner 170 fine-tunes the deep ensemble model 130 jointly using the subset of labeled test data samples 114 and the source training samples D^{tr} to avoid over-fitting the deep ensemble model 130 to the small subset of labeled test data samples 114 and prevent the deep ensemble model 130 from forgetting the source training knowledge. The fine-tuner 170 may fine-tune the deep ensemble model 130 using a training objective that includes SGD and/or a KL-Divergence loss. In some implementations, the fine-tuner 170 fine-tunes each machine learning model 130 of the deep ensemble model 130 independently via SGD with different randomness on the subset of labeled test data samples 114 using the training objective of:

$$\begin{matrix}min \\ {θ}^{j}\end{matrix} {𝔼}_{( x , y ) ∈ {⋃}_{l = 1}^{t} {\tilde{B}}_{l}} {ℓ}_{CE} ( x , y ; {θ}^{j} ) + λ \cdot {𝔼}_{( x , y ) ∈ {D}^{tr}} {ℓ}_{CE} ( x , y ; {θ}^{j} ) \qquad ( 2 )$$

In Equation 2, θ^{j} represents model parameter of the deep ensemble model 130 and A represents a hyper parameter that controls the amount of joint training between the subset of labeled test data samples 114 and the source training samples D^{tr}. As shown in Equation 2, the fine-tuner 170 determines a cross-entropy loss ( [symbol] _{CE}) and fine-tunes the deep ensemble model 130 using the cross-entropy loss. In particular, fine-tuning the deep ensemble model 130 includes processing each labeled test data sample 114 to make a prediction (e.g., either using the deep ensemble model 130 or each machine learning model 130 independently) and comparing the prediction to the ground truth label 162 determined by the oracle 160 to determine the cross-entropy loss. Based on the cross-entropy loss, the fine-tuner 170 updates parameters of the deep-ensemble model 130.

After fine-tuning the deep ensemble model 130 on the subset of labeled test data samples 114, the model trainer 110 determines a second average output 172 for each unlabeled test data sample 112 of the set of unlabeled test data samples 112 using the fine-tuned deep ensemble model 130. In contrast to determining the first average outputs 122 using the deep ensemble model 130 pre-trained on the plurality of source training samples D^{tr}, the model trainer 110 determines the second average outputs 172 using the deep ensemble model 130 fine-tuned on the subset of labeled test data samples 114. Using the set of unlabeled test data samples 112 and the determined second average outputs 172, the model trainer 110 generates a pseudo-labeled set of training data samples 116. In contrast to the subset of labeled test data samples 114, the predictions generated by the fine-tuned deep ensemble model 130 serve as the ground truth labels for the pseudo-labeled set of training data samples 116 (e.g., instead of the ground truth labels 162 generated by the oracle 160).

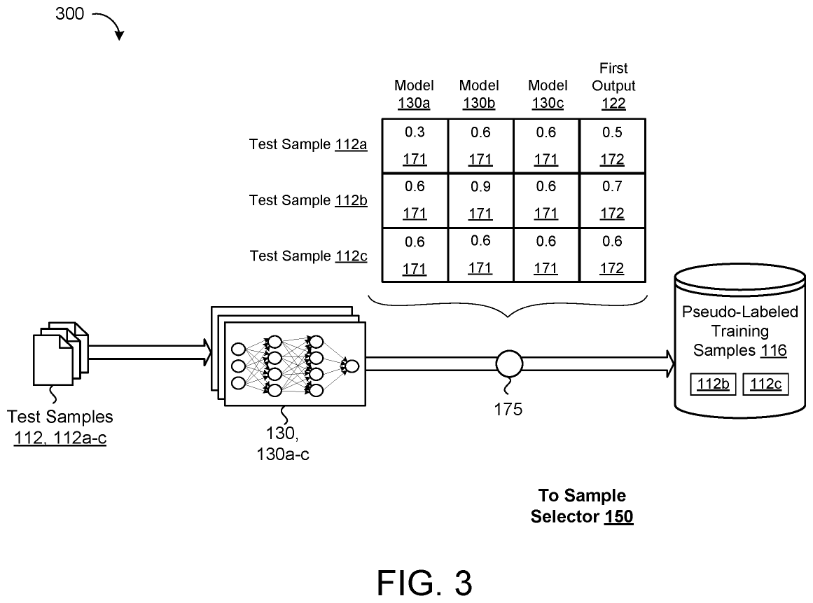

FIG. 3 shows a schematic view 300 of generating the pseudo-labeled set of training data samples 116. In the example shown, the fine-tuned deep ensemble model 130 includes three fine-tuned machine learning models 130a-c and the set of unlabeled test data samples 112 includes three unlabeled test data samples 112a-c, however, the fine-tuned deep ensemble model 130 may include any number of machine learning models 130 and the set of unlabeled test data samples 112 may include any number of data samples. Each machine learning model 130 of the deep ensemble model 130 generates a respective output 175 for each respective unlabeled test data sample 112. Each output 175 may include a prediction (not shown) for the respective unlabeled test data sample 112 and a confidence value 171 (e.g., softmax output value) indicating a likelihood that the prediction generated by the machine learning model 130 is correct. The prediction may be a classification, transcription, or other prediction based on processing the unlabeled test data sample 112. For instance, for a respective unlabeled test data sample 112 including audio data, the prediction may be a transcription of speech included in the audio data. Here, the confidence value 171 would indicate the likelihood that the transcription accurately reflects the speech included in the audio data.

In the example shown, the first machine learning model 130a determines confidence values 171 of 0.3, 0.6, and 0.6 for the three unlabeled test data samples 112a-c, respectively. Similarly, the second machine learning model 130b determines confidence values 171 of 0.6, 0.9, and 0.6 for the three unlabeled test data samples 112a-c, respectively, and the third machine learning model 130c determines confidence values 121 of 0.6, 0.6, and 0.6 for the three unlabeled test data samples 112a-c, respectively. As such, the fine-tuned deep ensemble model 130 determines the second average output 172 for each respective unlabeled test data sample 112 by averaging the confidence values 171 generated by each fine-tuned machine learning model 130 of the fine-tuned deep ensemble model 130 for each respective unlabeled test data sample 112. For instance, for the first unlabeled test data sample 112a, the fine-tuned deep ensemble model 130 determines the second average output 172 of 0.5 by averaging the three confidence values 171 of 0.3, 0.6, and 0.6 determined by each of the fine-tuned machine learning models 130 of the fine-tuned deep ensemble model 130. Similarly, the fine-tuned deep ensemble model 130 determines the second average output 172 of 0.7 for the second unlabeled test data sample 112b and the second average output of 0.6 for the third unlabeled test data sample 112c.

The model trainer 110 may generate the pseudo-labeled set of training data samples 116 by selecting, from the unlabeled test data samples 112, unlabeled test data samples 112 for which the fine-tuned deep ensemble model 130 determined corresponding second average outputs 172 that satisfy a confidence threshold. Thus, for each determined second average output 172, the model trainer 110 determines whether the second average output 172 satisfies the confidence threshold. The confidence threshold may be any value and is configurable. As such, a lower confidence threshold leads to more unlabeled test samples 112 being added to the pseudo-labeled set of training data samples 116 and a higher confidence threshold leads to less unlabeled test data samples 112 being added to the pseudo-labeled set of training data samples 116.

Continuing with the example shown, the confidence threshold is 0.55 such that the model trainer 110 selects the second unlabeled test data sample 112b and the third unlabeled test data sample 112c to be included in the pseudo-labeled set of training data samples 116. Notably, the predictions generated by the fine-tuned deep ensemble model 130 for the unlabeled test data samples 112 included in the pseudo-labeled set of training data samples serve as the ground truth labels during training. That is, since the second average outputs 172 satisfy the confidence threshold (e.g., indicating the predictions have a sufficient likelihood of being correct), the predictions generated by the fine-tuned deep ensemble model 130 serve as the ground truth labels rather than deferring to the oracle to manually label the unlabeled test data samples 112.

Referring again to FIG. 1, thereafter, a final trainer 180 further trains the fine-tuned deep ensemble model 130 using the pseudo-labeled set of training data samples 116 whereby the predictions generated by the fine-tuned deep ensemble model 130 serve as ground truth labels during this stage of training. The final trainer 180 may train the deep ensemble model 130 using a training objective that includes SGD and/or a KL-Divergence loss. In some implementations, the final trainer 180 trains each machine learning model 130 of the deep ensemble model 130 independently via SGD with different randomness on the pseudo-labeled set of training data samples 116. The final trainer 180 may select a subset of the pseudo-labeled set of training data samples 116 to train the deep ensemble model 130 by randomly selecting a predetermined number of training samples.

In some implementations, the deep ensemble model 130 (and each machine learning model 130) includes a scoring component and a prediction component. The scoring component is configured to generate the confidence values 121, 171 and the prediction component is configured to generate the predictions. The scoring component and the prediction component have distinct trainable parameters. As such, during fine-tuning and training, the model trainer 110 may update parameters of the scoring component and the prediction component independently. That is, the model trainer 110 trains the scoring component to make accurate confidence value 121, 171 predictions and the prediction component to make accurate predictions. Conventional systems simply train models to make accurate predictions without any regard to making accurate confidence value 121, 171 predictions. Consequently, when using selective prediction and active learning, failing to train models to make accurate confidence value 121, 171, predictions may inadvertently cause the model to defer predictions to human annotators that the model predicted correctly or fail to defer predictions to human annotators that the model predicted incorrectly.

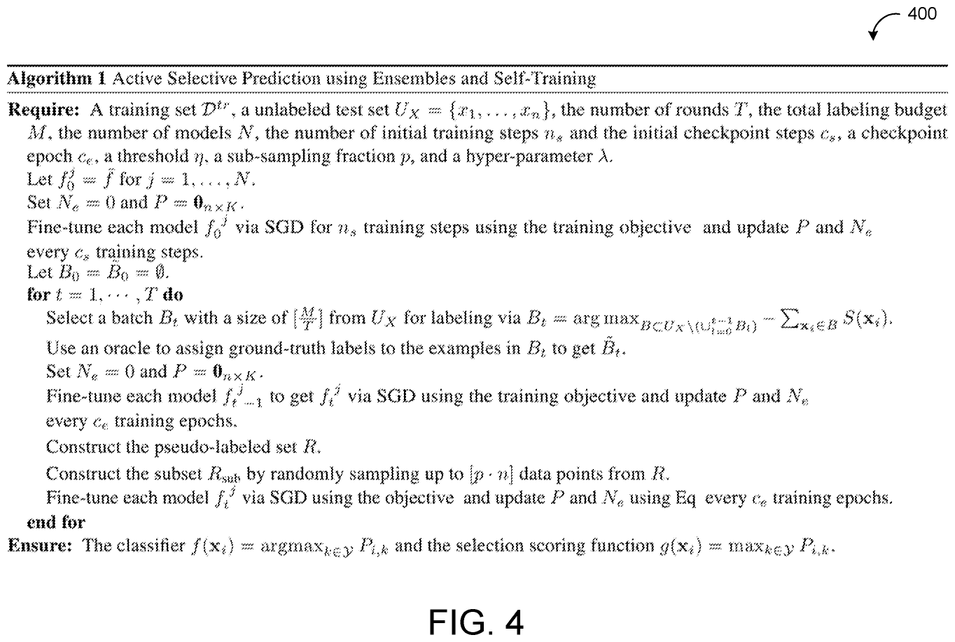

FIG. 4 illustrates an example algorithm 400 that the model trainer 110 may use to train the deep ensemble model 130. As described above, the model trainer 110 combines selective prediction and active learning to train the deep ensemble model 130. In particular, the model trainer 110 uses active learning by selecting the subset of unlabeled test data samples 112S for labeling by the oracle 160 and uses the labeled subset of labeled test data samples 114 to fine-tune the deep ensemble model 130. Thereafter, the model trainer 110 uses selective prediction by using the fine-tuned deep ensemble model 130 to generate predictions and second average outputs 172 for each unlabeled test data sample 112. Unlabeled test data samples 112 that the fine-tuned deep ensemble model 130 determined a second average output 172 that satisfies the confidence threshold (e.g., indicating that the prediction has a high likelihood of being correct) are added to the pseudo-labeled set of training data samples 116. On the other hand, unlabeled test data samples 112 that the fine-tuned deep ensemble model 130 determined a second average output 172 that fails to satisfy the confidence threshold (e.g., indicating that the prediction has a low likelihood of being correct) are sent to the oracle 160 for human annotation and further fine-tuning. Advantageously, by initially fine-tuning the deep-ensemble model using the labeled test data samples 114, the model trainer 110 increases the number of samples that the deep ensemble model 130 makes confident prediction for, and thus, are added to the pseudo-labeled set of training data samples 116 and minimizes the number of samples labeled by the oracle 160. Yet, samples that the fine-tuned deep ensemble model 130 still makes low confidence predictions for are sent to the oracle 160 for labeling and further fine-tuning. This approach combines selective prediction and active learning to minimize the amount of human intervention (e.g., labeling) required to train the deep ensemble model 130.

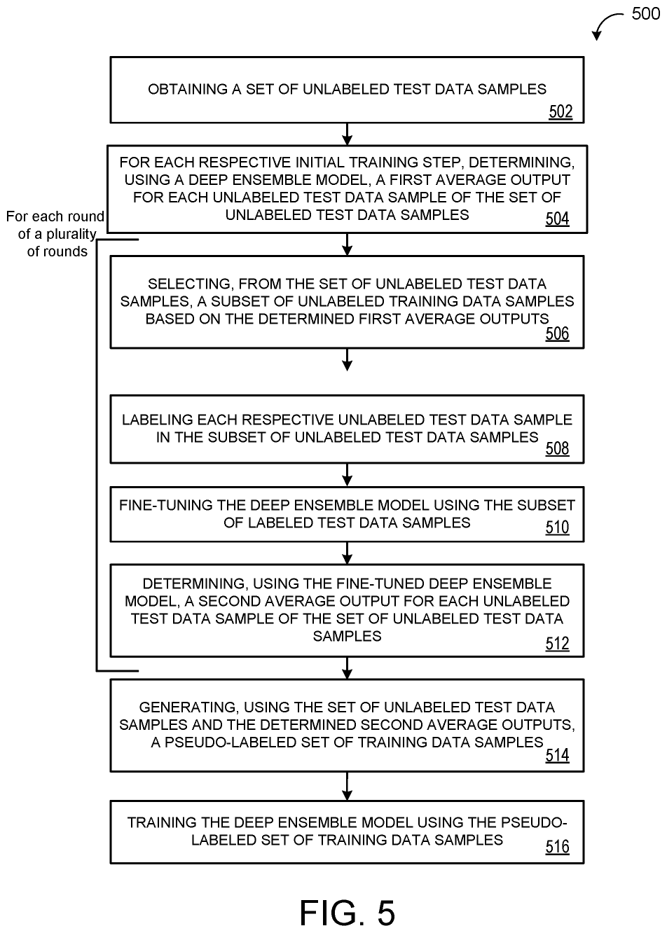

FIG. 5 is a flowchart of an exemplary arrangement of operations for a method 500 of performing active selective prediction using ensembles and self-training. The computer-implemented method 500, when executed by data processing hardware 12, causes the data processing hardware 12 to perform operations. At operation 502, the method 500 includes obtaining a set of unlabeled test data samples 112. At operation 504, for each respective initial training step 200, the method 500 includes determining, using a deep ensemble model 130 pre-trained on a plurality of source training samples, a first average output 122 for each unlabeled test data sample 112.

For each round of a plurality of rounds, the method 500 performs operations 506-512. At operation 506, the method 500 includes selecting, from the set of unlabeled test data samples 112, a subset of unlabeled test data samples 112S based on the determined first average outputs 122. At operation 508, the method 500 includes labeling each respective unlabeled test data sample 112 in the subset of unlabeled test data samples 112 to form a subset of labeled test data samples 114. At operation 510, the method 500 includes fine-tuning the deep ensemble model 130 using the subset of labeled test data samples 114. At operation, 512, the method 500 includes determining a second average output 172 for each unlabeled test data sample 112 of the set of unlabeled test data samples 112 using the fine-tuned deep ensemble model 130. At operation 514, the method 500 includes generating a pseudo-labeled set of training data samples 116 using the set of unlabeled test data samples 112 and the determined second average outputs 172. At operation 516, the method 500 includes training the deep ensemble model 130 using the pseudo-labeled set of training data samples 116.

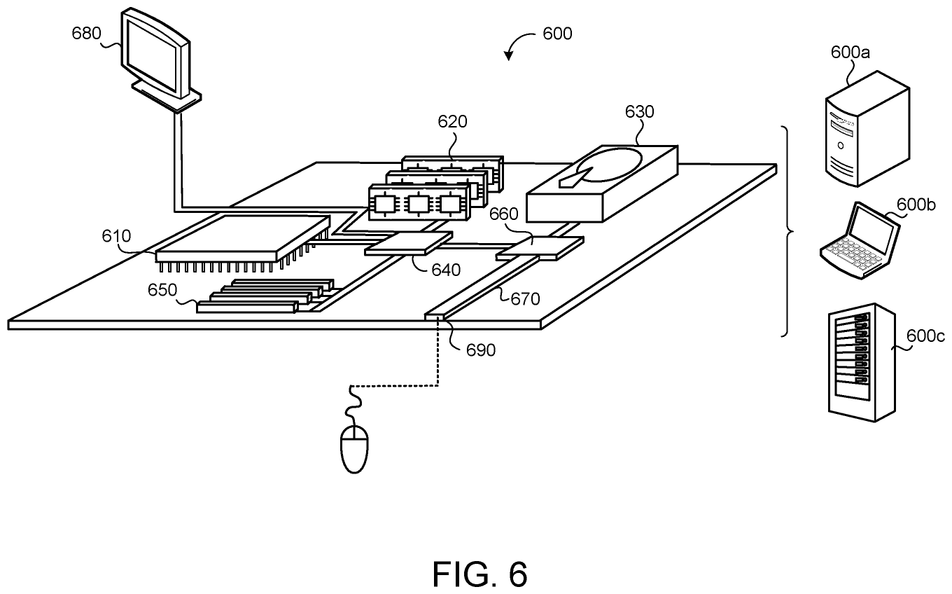

FIG. 6 is a schematic view of an example computing device 600 that may be used to implement the systems and methods described in this document. The computing device 600 is intended to represent various forms of digital computers, such as laptops, desktops, workstations, personal digital assistants, servers, blade servers, mainframes, and other appropriate computers. The components shown here, their connections and relationships, and their functions, are meant to be exemplary only, and are not meant to limit implementations of the inventions described and/or claimed in this document.

The computing device 600 includes a processor 610, memory 620, a storage device 630, a high-speed interface/controller 640 connecting to the memory 620 and high-speed expansion ports 650, and a low speed interface/controller 660 connecting to a low speed bus 670 and a storage device 630. Each of the components 610, 620, 630, 640, 650, and 660, are interconnected using various busses, and may be mounted on a common motherboard or in other manners as appropriate. The processor 610 can process instructions for execution within the computing device 600, including instructions stored in the memory 620 or on the storage device 630 to display graphical information for a graphical user interface (GUI) on an external input/output device, such as display 680 coupled to high speed interface 640. In other implementations, multiple processors and/or multiple buses may be used, as appropriate, along with multiple memories and types of memory. Also, multiple computing devices 600 may be connected, with each device providing portions of the necessary operations (e.g., as a server bank, a group of blade servers, or a multi-processor system).

The memory 620 stores information non-transitorily within the computing device 600. The memory 620 may be a computer-readable medium, a volatile memory unit(s), or non-volatile memory unit(s). The non-transitory memory 620 may be physical devices used to store programs (e.g., sequences of instructions) or data (e.g., program state information) on a temporary or permanent basis for use by the computing device 600. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

The storage device 630 is capable of providing mass storage for the computing device 600. In some implementations, the storage device 630 is a computer-readable medium. In various different implementations, the storage device 630 may be a floppy disk device, a hard disk device, an optical disk device, or a tape device, a flash memory or other similar solid state memory device, or an array of devices, including devices in a storage area network or other configurations. In additional implementations, a computer program product is tangibly embodied in an information carrier. The computer program product contains instructions that, when executed, perform one or more methods, such as those described above. The information carrier is a computer- or machine-readable medium, such as the memory 620, the storage device 630, or memory on processor 610.

The high speed controller 640 manages bandwidth-intensive operations for the computing device 600, while the low speed controller 660 manages lower bandwidth-intensive operations. Such allocation of duties is exemplary only. In some implementations, the high-speed controller 640 is coupled to the memory 620, the display 680 (e.g., through a graphics processor or accelerator), and to the high-speed expansion ports 650, which may accept various expansion cards (not shown). In some implementations, the low-speed controller 660 is coupled to the storage device 630 and a low-speed expansion port 690. The low-speed expansion port 690, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The computing device 600 may be implemented in a number of different forms, as shown in the figure. For example, it may be implemented as a standard server 600a or multiple times in a group of such servers 600a, as a laptop computer 600b, or as part of a rack server system 600c.

Various implementations of the systems and techniques described herein can be realized in digital electronic and/or optical circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

A software application (i.e., a software resource) may refer to computer software that causes a computing device to perform a task. In some examples, a software application may be referred to as an “application,” an “app,” or a “program.” Example applications include, but are not limited to, system diagnostic applications, system management applications, system maintenance applications, word processing applications, spreadsheet applications, messaging applications, media streaming applications, social networking applications, and gaming applications.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

The processes and logic flows described in this specification can be performed by one or more programmable processors, also referred to as data processing hardware, executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

A number of implementations have been described. Nevertheless, it will be understood that various modifications may be made without departing from the spirit and scope of the disclosure. Accordingly, other implementations are within the scope of the following claims.

What is claimed is:

1. A computer-implemented method executed by data processing hardware that causes the data processing hardware to perform operations comprising:
obtaining a set of unlabeled test data samples;
for each respective initial training step of a plurality of initial training steps, determining, using a deep ensemble model pre-trained on a plurality of source training samples, a first average output for each unlabeled test data sample of the set of unlabeled test data samples;
for each round of a plurality of rounds:
selecting, from the set of unlabeled test data samples, a subset of unlabeled test data samples based on the determined first average outputs;
labeling each respective unlabeled test data sample in the subset of unlabeled test data samples;
fine-tuning the deep ensemble model using the subset of labeled test data samples; and
determining, using the fine-tuned deep ensemble model, a second average output for each unlabeled test data sample of the set of unlabeled test data samples;
generating, using the set of unlabeled test data samples and the determined second average outputs, a pseudo-labeled set of training data samples; and
training the deep ensemble model using the pseudo-labeled set of training data samples.

2. The method of claim 1, wherein labeling each respective unlabeled test data sample in the set of unlabeled test data samples comprises obtaining, from an oracle, for each respective unlabeled test data sample in the set of unlabeled test data samples, a corresponding label for the respective unlabeled test data sample.

3. The method of claim 2, wherein the oracle comprises a human annotator.

4. The method of claim 1, wherein training the deep ensemble model using the pseudo-labeled set of training data samples comprises using a stochastic gradient descent technique.

5. The method of claim 1, wherein:
the deep ensemble model comprises an ensemble of one or more machine learning models; and
training the deep ensemble model using the pseudo-labeled set of training data samples comprises training each machine learning model with a different randomly selected subset of the pseudo-labeled set of training data samples.

6. The method of claim 5, wherein determining the first average output for each unlabeled test data sample comprises, for each respective unlabeled test data sample:
for each machine learning model of the one or more machine learning models, determining a prediction and a confidence value indicating a likelihood that the prediction is correct; and
averaging the confidence values determined by each machine learning model for the respective unlabeled test data sample.

7. The method of claim 1, wherein selecting, from the set of unlabeled test data samples, the subset of unlabeled test data samples based on the determined first average outputs comprises selecting the unlabeled test data samples comprising the lowest determined first average outputs.

8. The method of claim 1, wherein fine-tuning the deep ensemble model using the subset of labeled test data samples comprises jointly fine-tuning the deep ensemble model using the subset of labeled test data samples and the plurality of source training samples.

9. The method of claim 1, wherein fine-tuning the deep ensemble model using the subset of labeled test data samples comprises determining a cross-entropy loss.

10. The method of claim 1, wherein training the deep ensemble model using the pseudo-labeled set of training data samples comprises determining a KL-Divergence loss.

11. A system comprising:
data processing hardware; and
memory hardware in communication with the data processing hardware, the memory hardware storing instructions that when executed on the data processing hardware cause the data processing hardware to perform operations comprising:
obtaining a set of unlabeled test data samples;
for each respective initial training step of a plurality of initial training steps, determining, using a deep ensemble model pre-trained on a plurality of source training samples, a first average output for each unlabeled test data sample of the set of unlabeled test data samples;
for each round of a plurality of rounds:
selecting, from the set of unlabeled test data samples, a subset of unlabeled test data samples based on the determined first average outputs;
labeling each respective unlabeled test data sample in the subset of unlabeled test data samples;
fine-tuning the deep ensemble model using the subset of labeled test data samples; and
determining, using the fine-tuned deep ensemble model, a second average output for each unlabeled test data sample of the set of unlabeled test data samples;
generating, using the set of unlabeled test data samples and the determined second average outputs, a pseudo-labeled set of training data samples; and
training the deep ensemble model using the pseudo-labeled set of training data samples.

12. The system of claim 11, wherein labeling each respective unlabeled test data sample in the set of unlabeled test data samples comprises obtaining, from an oracle, for each respective unlabeled test data sample in the set of unlabeled test data samples, a corresponding label for the respective unlabeled test data sample.

13. The system of claim 12, wherein the oracle comprises a human annotator.

14. The system of claim 11, wherein training the deep ensemble model using the pseudo-labeled set of training data samples comprises using a stochastic gradient descent technique.

15. The system of claim 11, wherein:
the deep ensemble model comprises an ensemble of one or more machine learning models; and
training the deep ensemble model using the pseudo-labeled set of training data samples comprises training each machine learning model with a different randomly selected subset of the pseudo-labeled set of training data samples.

16. The system of claim 15, wherein determining the first average output for each unlabeled test data sample comprises, for each respective unlabeled test data sample:
for each machine learning model of the one or more machine learning models, determining a prediction and a confidence value indicating a likelihood that the prediction is correct; and
averaging the confidence values determined by each machine learning model for the respective unlabeled test data sample.

17. The system of claim 11, wherein selecting, from the set of unlabeled test data samples, the subset of unlabeled test data samples based on the determined first average outputs comprises selecting the unlabeled test data samples comprising the lowest determined first average outputs.

18. The system of claim 11, wherein fine-tuning the deep ensemble model using the subset of labeled test data samples comprises jointly fine-tuning the deep ensemble model using the subset of labeled test data samples and the plurality of source training samples.

19. The system of claim 11, wherein fine-tuning the deep ensemble model using the subset of labeled test data samples comprises determining a cross-entropy loss.

20. The system of claim 11, wherein training the deep ensemble model using the pseudo-labeled set of training data samples comprises determining a KL-Divergence loss.
